(19) United States
(12) Patent Application Publication
(10) Pub. No.: US 2024/0268003 A1
(43) Pub. Date: Aug. 8, 2024

(54) Dual-Access Microwave Oven

(71) Applicant: Paul Hastings, Oakville (CA)

(72) Inventor: Paul Hastings, Oakville (CA)

(21) Appl. No.: 18/234,762

(22) Filed: Aug. 16, 2023

(30) Foreign Application Priority Data
Feb. 3, 2023 (CA) 3189376

(51) Int. Cl. H05B 6/64

(52) U.S. Cl. CPC H05B 6/6402

(57) ABSTRACT

“In microwave ovens that cook food, it is known that appliances use the main magnetron at the side of the oven compartment in combination with a turntable for even heating of food where the oven access is in front. This dual-access microwave oven uses top positioning of the magnetron without a turntable and with oven access in front and in back for a compact oven depth and where the oven access is also allowed from multiple sides and the wide distribution of the internally reflected microwaves including from an above wave stirrer where the controls for microwave oven operation are at the top and external to the oven chamber. Heating of the food product that is inserted from one direction and accessed from another is controlled with an electromagnetic lock that controls oven door access and the placement of the operational interface of the appliance.”

Technical Field: This invention relates to an electronic microwave oven appliance for heating and cooking food products, that are to be heated from an initial temperature to the desired temperature where when the operation is complete the inserted product through one opening is then retrieved in a controlled procedure from another opening.

Background of the Invention: It is common in microwave appliances in commercial, industrial and residential use, for front inserted products to be heated for use from a side mounted magnetron and a turntable. As microwave ovens are subject to sparking when certain foreign items are inserted, this bespoke microwave oven with the centrally positioned magnetron above the oven compartment creating a more even distribution of the microwaves without using a turntable, the controlled oven access using a magnetic locking system on the oven door allows permitted and controlled use to deter vandalism. Uniform distribution of the reflected microwaves in the oven compartment is increased by using the directional wave guide feature and motorized rotating stirrer fan which are above the said oven compartment. The activating panel for microwave operation is positioned to suit the controlling operational side such as in facilities and locations where the monitored and permitted use of the microwave is required. Other functions of the microwave appliance are maintained and provided and the controls for temperature selection and heating duration are above but outside the oven as is typical for microwave oven appliance operation. Specifically, the controls, magnetron, capacitor, diodes, transformer, resistors, cooling fan, motor, fuse, incoming electrification service and vent holes are horizontally positioned above the oven compartment, which oven compartment has reflective surfaces for the microwaves, including where the reflective viewing access panel to the oven is required. The main hinged access panel is interlocked to prevent microwave operation when an access panel to the oven is open which is similarly applied to the other hinged access panels located for direct oven access. As well, the double dual-access oven design where one microwave oven is conjoined with the adjacent microwave oven allows expansion of the microwave oven to be extended using a common system control.

Summary of the Invention: In order to use the dual-access microwave oven, the food product is manually inserted from the rear operational service side through an opening having an access panel with automation also being used to horizontally supply the food product into the oven cavity where a heating cycle is initiated from an interface on the said operational service side. When the prescribed desired temperature is reached for the condition of the food product, by stopping the heating cycle duration by the microwaves, the electromagnetic hold on the output side access panel covering the opening, secures it to the appliance frame allowing the access panel to be released from covering the opening. Additional safety is provided by the interlock circuit ensuring the microwave action is ended for the related microwave oven compartment. The interlock circuitry at the food input operational service side provides safety to ensure the microwave action does not occur during the food input process when the access panel is open. The vertical slide panel on the exterior of the appliance that covers the food input opening that is accessed through an inner access panel protects from microwave exposure.

The invention having the upper electronic compartment above lower oven compartment and with the connection to the electrical source for the appliance to energize the system electronics and system interfaces for controlled activation of microwave heating of the food products in the lower food cavity is an invention for controlled input and output of cooked products. Air vents in the appliance enclosure provide inlets for cooling and outlets for exhaust to the exterior so overheating of the appliance and components does not occur. The invention allows the design of an elongated compact oven with a narrow depth profile without a turntable when it is conjoined and extended with a similar microwave appliance. This allows space saving, energy saving and operational saving for supervisory use.

Brief Description of the Drawings: In drawings which illustrate embodiments of the invention of the dual access microwave oven, —

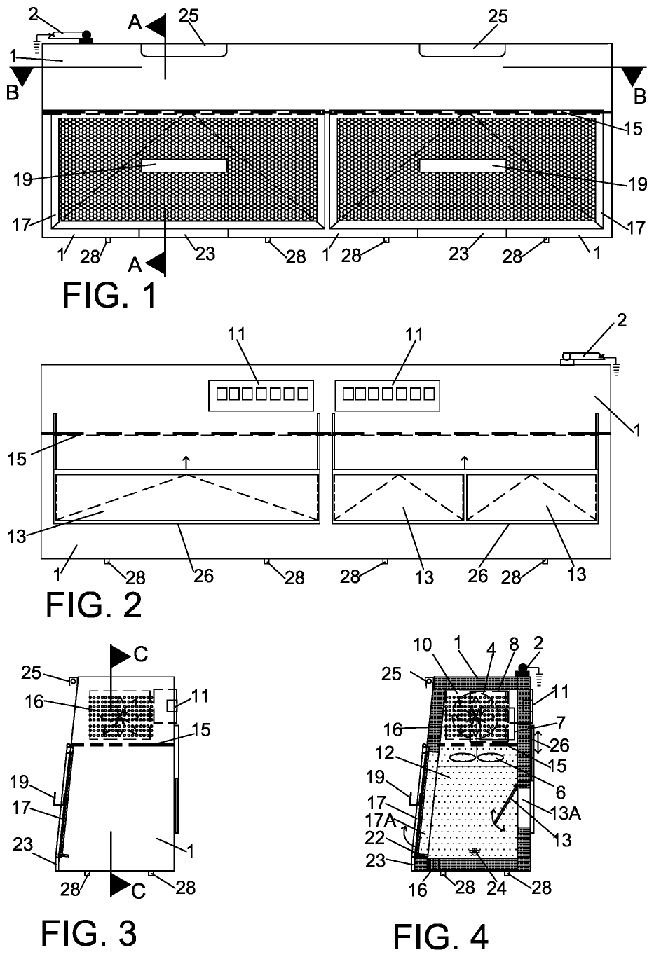

FIG. 1—illustrates a Front Elevation view of the microwave oven appliance to show the access openings for food output below the enclosed electronic compartment, the handle for opening the oven access, the Spectrum C ultraviolet light at the top face of the appliance to sanitize the handle and the electromagnetic lock below the handle for vandalism control. (Indicated as FIG. 1)

FIG. 2—illustrates the Rear Elevation view of the microwave oven appliance to show the access openings for food input into the oven where it is covered by a vertical sliding exterior cover, the control interfaces for the separate oven compartments. (Indicated as FIG. 2)

FIG. 3—illustrates a Side Elevation view of the microwave appliance to show the division between the upper and lower compartments, the side vent holes for the upper electronic compartment and the relationship of the interface controls and power supply. (Indicated as FIG. 3)

FIG. 4—illustrates a Vertical Transverse Section thru the appliance of the upper electronic compartment with the electronic systems and the lower microwave oven with the front output opening with access panel and rear input access opening with cover, the vertical sliding cover and incoming power supply. (Indicated as FIG. 4)

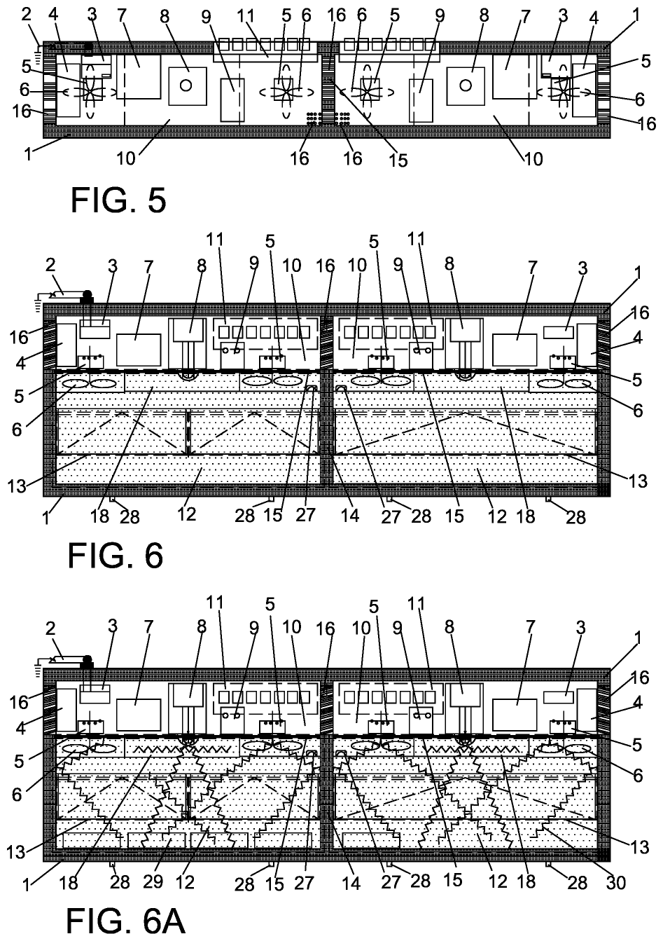

FIG. 5—illustrates a Horizontal section thru the upper electronic section to show the electronic components that include the magnetron, capacitor, transformer, stirrer fan motor and cooling fan. (Indicated as FIG. 5)

FIG. 6—illustrates a Vertical Longitudinal Section thru the microwave appliance to show the upper electronic compartment with the electronic components with incoming electrical supply and vents, and the lower microwave oven compartment with the input access doors. (Indicated as FIG. 6)

FIG. 6A—similar to FIG. 6 to illustrate schematic microwaves and product occupancy. (Indicated as FIG. 6A)

Detailed Description: The microwave appliance is illustrated as a vented metallic cabinet identified as item 1 that is divided horizontally by (-15) into 2 main sections identified as (-10) and (-12), (see FIG. 4 and FIGS. 6 and 6A) and vertically by (-14) identified as (-10) and (-12) into 2 similarly functioning sections with the electronic components above and the oven below. The upper section houses the main electronic components in an upper compartment, (see FIG. 4, FIGS. 6 and 6A) where the power supply identified as (-2) connects to distributive power modules with fuse and electrical coil identified as item (-3); The electrification using 120 Volt alternating current from (-2), powers the cooling fan identified as (-4), the other electronic components including the magnetron with connected resistors identified as (-8), the capacitor with connected diode identified as (-9), the transformer identified as (-7), the stirrer fan identified as (-6) with motor identified as (-5), and the control interface identified as (-11) which controls aspects of heat cycle duration, cycle start and finish, activation and release of the magnetic lock identified as (-23), (see FIG. 1 and FIG. 4), the interlock identified as (-22) for power shut off when access panels are opened (see FIG. 4) and oven light indicated as (-27), (see FIG. 6, FIG. 6A). As equipment heat is generated in the upper electronic compartment and oven compartment, the vent holes identified as -16 allow air flow, (see FIG. 3, FIG. 4, FIG. 5, FIG. 6, FIG. 6A). Clearance of under cabinet venting is provided by supports shown as (-28), (see FIG. 1, FIG. 2, FIG. 3, FIG. 4, FIG. 6, FIG. 6A).

The microwave appliance has the exterior output access handle indicated as (-19), (see FIG. 1, FIG. 3, FIG. 4) for lifting the oven door indicated as (-17) which covers opening (-17A), (see FIG. 1, FIG. 3, FIG. 4) for product output. The handle (-19) is sanitized by the UVC light identified as (-25), (see FIG. 1, FIG. 3, FIG. 4). The input access at the rear into the oven compartment is indicated as (-13) which covers opening 13A, (see FIG. 2, FIG. 4, FIG. 6, FIG. 6A) where it is protected by the sliding cover identified as (-26), (see FIG. 2, FIG. 4) and prevents microwaves leaving the oven compartment. The occupancy sensor identified as (-24), (see FIG. 4) controls activity if a product is inserted into the microwave oven without system activation and when a product remains in the oven when system activation cycle is completed.

Overview: The schematic microwaves in the oven indicated as (-30) that heat the product indicated as (-29) (see FIG. 6A) show the intended wave distribution and reflection that replaces the turntable function. The wave guide indicated as (-18) provides the intended wave action generated from the magnetron identified as (-8), (see FIG. 6A). The dual openings with access covers for controlled use allow the enhanced safe functionality in open environment where vandalism can occur. Servicing of the appliance involves the separation of the 2-part enclosure where the upper enclosure for the electronic components is separated from the lower enclosure around the oven compartment when the fasteners are removed.

### Summary of Listed Items on FIG. 1, FIG. 2, FIG. 3, FIG. 4, FIG. 5, FIG. 6 and FIG. 6A.

| Item | Name | Description | Shown on FIG. |
|---|---|---|---|
| 1. | Appliance Enclosure | 2 piece microwave appliance enclosure | 1, 2, 3, 4, 5, 6, 6A |
| 2. | Power Supply | 120 V power supply | 1, 2, 3, 4, 5, 6, 6A |
| 3. | Power Module | System power distribution module with fuse and coil | 5, 6, 6A |
| 4. | Cooling Fan | Cooling fan for electronic components compartment | 4, 5, 6, 6A |
| 5. | Stirrer Fan Motor | Motor to rotate stirrer fan in MW oven | 5, 6, 6A |
| 6. | Stirrer Fan | Fan to distribute generated microwaves from Magnetron | 4, 5, 6, 6A |
| 7. | Transformer | Current regulator for voltage change | 5, 6, 6A |
| 8. | Magnetron | Microwave generator | 8, 5, 6, 6A |
| 9. | Capacitor | Electrical Energy storage | 5, 6, 6A |
| 10. | Electronic Compartment | Horizontal compartment with electronic components | 4, 5, 6, 6A |
| 11. | Control Interface | Input for MW appliance activity | 2, 3, 4, 5, 6, 6A |
| 12. | Oven Compartment | Horizontal compartment with oven access | 4, 6, 6A |
| 13. | Input Access Flap - 13A | 13-Movable cover with magnetic strip and circuit break | 2, 4, 6, 6A |
| | | contact on base edge with interior face of oven for rear 13A | |
| | | access opening to MW oven | |
| 14. | Vertical Divider | Separator for upper and lower compartments from adjacent | 5, 6, 6A |
| | | upper and lower compartments | |
| 15. | Horizontal Divider | Separator of upper compartments from adjacent lower | 1, 2, 3, 6, 6A |
| | | compartments | |
| 16. | Vent | Screened opening for air inlet or air outlet | 3, 4, 5, 6, 6A |
| 17. | Output Access Flap- 17A | 17-Movable cover with metal mesh having holes smaller | 1, 3, 4, |
| | | than the wavelength to allow viewing through front 17A | |
| | | access opening to MW oven | |
| 18. | Wave Guide | Horizontal compartment to direct microwaves | 6, 6A |
| 19. | Handle | Hardware to lower or raise access cover of opening | 1, 3, 4, |
| 20. | —Access flap stop | Limit of travel of front access flap | 1, 3, 4 |
| 21. | —Not used | — | |
| 22. | Interlock | Circuit connector to break or complete MW generation | 4 |
| 23. | Maglok | Security magnetic holding device for vandalism prevention | 1, 4 |
| 24. | Sensor | Device to detect product occupancy | |
| 25. | Ultraviolet Light | UVC for germ sanitation of handle | 1, 3, 4 |
| 26. | Flap Cover | Sliding plate to prevent microwave escape | 2, 4 |
| 27. | Light | Oven illumination | 6, 6A |
| 28. | Support | Material to raise MW appliance for vent clearance | 1, 2, 3, 4, 6, 6A |
| 29. | Product | Food product to be heated | 6A |
| 30. | Microwave | Schematic MW distribution | 6A |
| 31. | —Not used | — | |
| 32. | —Not used | — | |

1. A microwave appliance for food products comprising a plurality of walls with an upper horizontally aligned electronic component compartment for the generation of microwaves for the lower horizontally aligned oven below and with the said lower horizontally aligned microwave oven below having a separate closable opening access to input the food product and another separate closable opening access to output the food product after the heating cycle is completed where the wave distribution provides even product heating and the separate closable output access is securable and controlled using an electronic magnetic lock where a control interface module governs the system operation to include the exterior sanitizing of the output opening contact surface with ultraviolet light C.

2. A microwave appliance for food products as defined in claim 1 where the said microwave is extended horizontally using similar upper and lower configuration of the appliance having a vertical separation between the appliance extension.

3. A microwave appliance for food products as defined in claim 1 and claim 2, where an external automated food insertion device can horizontally input the food product into the lower horizontally aligned oven compartment through the input access opening where the device is incorporated with the control interface module.

4. A microwave appliance for food products as defined in claim 1, claim 2 and claim 3 where the compact design of the appliance provided by the horizontal disposition of the upper and lower compartments having a horizontally elongated axis relative to its depth and height.

5. A microwave appliance for food products as defined in claim 1, claim 2, claim 3 and claim 4 where the location of the microwave magnetron is positioned to allow asymmetrical horizontal placement relative to a wave stirrer to allow varying the number of wave stirrers in the upper horizontally aligned electronic compartment.
